(19) United States
(12) Patent Application Publication
(10) Pub. No.: US 2026/0168577 A1
(43) Pub. Date: Jun. 18, 2026

(54) SUPERIOR SEAL FOR OVERMOLDED ASSEMBLIES

(71) Applicant: Bentek Corporation, San Jose, CA (US)

(72) Inventor: Cheung Peng Hu, Palo Alto, CA (US)

(21) Appl. No.: 19/308,000

(22) Filed: Aug. 22, 2025

Related U.S. Application Data
(60) Provisional application No. 63/718,099, filed on Nov. 8, 2024.

(51) Int. Cl. F16J 15/10

(52) U.S. Cl. CPC F16J 15/104

(57) ABSTRACT

In one or more embodiments, system and method for providing a superior seal for an overmolded assembly using Coefficient of Thermal Expansion (CTE) compliant material are disclosed. The system includes at least one cable and an overmold for the at least one cable, wherein Coefficient of Thermal Expansion (CTE) compliant material is provided around the at least one cable, and the overmold is provided around the assembly of the at least one cable and the CTE compliant material such that the CTE compliant material is sandwiched between the at least one cable and the overmold for the at least one cable to form a seal preventing a gap formed between the at least one cable and the overmolding due to difference in coefficients of thermal expansion between the material used for the at least one cable and the material used for the overmold.

### REFERENCE TO RELATED APPLICATIONS

This application claims priority to U.S. Provisional Application No. 63/718,099, filed Nov. 8, 2024, the entire contents of which are incorporated herein by reference.

### FIELD OF THE INVENTION

The embodiments described herein relate generally to cables, and more particularly to environmental seals for cables.

### SUMMARY

In one or more embodiments, system and method for providing a superior seal for an overmolded assembly using Coefficient of Thermal Expansion (CTE) compliant material are disclosed.

In one or more embodiments, the system for providing a superior seal for an overmolded assembly for a cable includes at least one cable and an overmold for the at least one cable, wherein Coefficient of Thermal Expansion (CTE) compliant material is provided around the at least one cable, and the overmold is provided around the assembly of the at least one cable and the CTE compliant material such that the CTE compliant material is sandwiched between the at least one cable and the overmold for the at least one cable to form a seal preventing a gap formed between the at least one cable and the overmolding for at least one cable due to difference in coefficients of thermal expansion between the material used for the at least one cable and the material used for the overmold for at least one cable.

In one or more embodiments, the method for providing a superior seal for an overmolded assembly for a cable includes applying Coefficient of Thermal Expansion (CTE) compliant material to at least one cable forming an assembly; and applying overmolding on top of the CTE compliant material for at least one cable, forming a seal preventing a gap formed between the at least one cable and the overmolding for at least one cable due to difference in coefficients of thermal expansion between the material used for the at least one cable and the material used for the overmolding for at least one cable.

In one or more embodiments, the coefficient of thermal expansion of the CTE compliant material is compatible with that of the material used for the at least one cable and the material used for the overmolding for at least one cable.

### BRIEF DESCRIPTION OF THE DRAWINGS

FIG. 1 illustrates an example method for providing a superior seal for an overmolded assembly according to one or more embodiments described herein.

FIG. 2 illustrates an example system for providing a superior seal for an overmolded assembly according to one or more embodiments described herein.

FIG. 3 illustrates an example system for providing a superior seal for an overmolded assembly according to one or more embodiments described herein.

FIG. 4 illustrates an example system for providing a superior seal for an overmolded assembly according to one or more embodiments described herein.

### DETAILED DESCRIPTION

The embodiments described herein relate generally to providing a superior seal for an overmolded assembly and more particularly to providing a uniform seal using Coefficient of Thermal Expansion (CTE) compliant material for cables going through an enclosure.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Various methods are used to seal the inside of the cable from the outside environment, one such method is using epoxy. However, there may be some drawbacks to the epoxy method, for example, the material used for the cables and that used for the overmolding may not bond well with the epoxy, and applying epoxy may be difficult and time consuming. Another method is overmolding an internal layer, but this method is costly, labor intensive, and time consuming. Also, it limits the material usage. The following embodiments described herein are unique and improved methods/devices that provide a uniform seal with a compliant material for cables going through an enclosure to seal the inside of the cable from the outside environment.

In one or more embodiments, system and method for providing a superior seal for an overmolded assembly using Coefficient of Thermal Expansion (CTE) compliant material are disclosed.

In one or more embodiments, the system for providing a superior seal for an overmolded assembly for a cable includes at least one cable and an overmold for the at least one cable, wherein Coefficient of Thermal Expansion (CTE) compliant material is applied to the at least one cable, and the overmold is applied around the assembly of the at least one cable and the CTE compliant material, wherein the CTE compliant material is sandwiched between the at least one cable and the overmold for the at least one cable to form a seal preventing a gap formed between the at least one cable and the overmolding for at least one cable due to difference in coefficients of thermal expansion between the material used for the at least one cable and the material used for the overmold for at least one cable.

In one or more embodiments, the method for providing a superior seal for an overmolded assembly for a cable includes applying Coefficient of Thermal Expansion (CTE) compliant material to at least one cable forming an assembly; and applying overmolding on top of the CTE compliant material for at least one cable, forming a seal preventing a gap formed between the at least one cable and the overmolding for at least one cable due to difference in coefficients of thermal expansion between the material used for the at least one cable and the material used for the overmolding for at least one cable.

In one or more embodiments, the coefficient of thermal expansion of the CTE compliant material is compatible with that of the material used for the at least one cable and the material used for the overmolding for at least one cable.

This overmolding technology employs material shrinkage during the molding process to produce a uniform seal with a compliant material, effectively isolating the internal environment from the external environment.

As the cables are passed through an enclosure and as they undergo fluctuations in environmental factors, including but not limited to temperature changes, water may leak to the fuse due to difference in coefficient of thermal expansion (CTE) of the material used for the overmold and the material used for the cable. This leak may be prevented by adding a seal between the overmold and cable. The CTE compliant material used for such seal may be compatible and/or matching with that of the material used for the cable as well as the material used for the overmold.

Additionally, or alternatively, the material used for such seal may be chemically compatible and/or matching with that of the material used for the cable as well as the material used for the overmold.

Although the invention is described here for overmolded assembly for cable, a person skilled in art may readily understand that it not limited to cables as the design will work to seal onto any extension protruding outside of the overmolded assembly and any such use is also within the scope and spirit of this invention.

The purpose of this device/system and method is to make a quick and easy uniform seal with a compliant material for any cable subassemblies. A person skilled in the art may readily understand that this device/method could be utilized in a multitude of indoor and/or outdoor cable configurations that requires environmental seal and overmolding, and is within the spirit and scope of the present invention described herein. For example, overmolding of any cable assemblies may be used in solar products, consumer products, automotive products, etc. and overmolding of tubing assemblies may be used in biotech/medical tubing assemblies, fluid cooling/heating, gas tubing assemblies, and wearable devices, etc.

The device/system and method according to one or more embodiments described herein involve the following steps: at least one cable or wire is assembled with a CTE-compliant material, thereby forming a sub-assembly. An overmolding is then applied to encapsulate and protect the sub-assembly, wherein the overmolded plastic covers the CTE-compliant material. The overmolding is at a high temperature (or as plastic injection molding) when applied, referred to herein as an injection temperature, as the liquid plastic at the high temperature cools from the injection temperature to a cooler temperature, referred to herein as a resting temperature, it transitions from a liquid state to a solid state and results in reduction in size, also referred to herein as first shrinkage.

This reduction in size during the overmold material's liquid-to-solid phase shift, combined with the coefficient of thermal expansion (CTE) size change from high temperature to resting temperature, also referred to herein as second shrinkage, must exceed the CTE of the item being overmolded across the intended temperature range (e.g., −40° C. to 90° C.) and provide a uniform seal with a compliant material for cables going through an enclosure to seal the inside of the cable from the outside environment. Thus, the two shrinkages described herein may include shrinkage due to change of state and change of temperature.

The invention as claimed and described herein may provide following advantages:
1. Enhanced Environmental Seal: This invention addresses the challenge of creating a robust and reliable environmental seal in overmolding without the use of epoxy, multiple layers of overmolding, rubber-based overmolding, or complex methods to increase surface energy for bonding;
2. Versatile Material Compatibility: Any overmolding material that is compatible with the compliant material may be utilized, where the material may be compatible in chemical properties as well as physical properties;
3. Durability of Seal: The reliability of the environmental seal may be directly linked to the material's lifespan; for example, if the material has a lifespan of 20 years, the seal may last for 20 years; (because this seal experience very little movement in its year lifespan can be much longer)
4. Adaptive Design: This technology is suitable for various applications, including electrical, chemical, liquid, and gas environments.

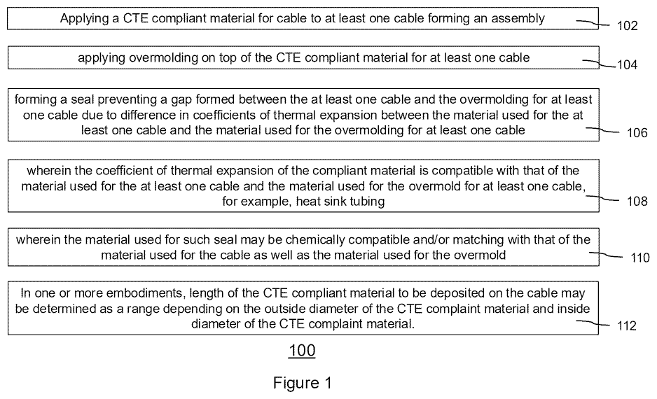

FIG. 1 illustrates an example method 100 for providing a superior seal for an overmolded assembly according to one or more embodiments described herein. For example, In one or more embodiments, the method for providing a superior seal for an overmolded assembly for a cable includes applying CTE compliant material for cable to at least one cable forming an assembly via step 102, for example, by applying heat shrink tubing; applying overmolding on top of the CTE compliant material for at least one cable via step 104, for example, by injecting liquid plastic which at high temperature (injection molding) on the assembly including the at least one cable and the CTE complaint material, forming a seal via step 106 preventing a gap formed between the at least one cable and the overmolding for at least one cable due to difference in coefficients of thermal expansion between the material used for the at least one cable and the material used for the overmolding for at least one cable.

In one or more embodiments, the coefficient of thermal expansion of the CTE compliant material is compatible with that of the material used for the at least one cable and the material used for the overmold for at least one cable, step 108.

Additionally, or alternatively, the material used for such seal may be chemically compatible and/or matching with that of the material used for the cable as well as the material used for the overmold, step 110.

In one or more embodiments, length of the CTE compliant material to be deposited on the cable may be determined as a range depending on the outside diameter of the CTE complaint material and inside diameter of the CTE complaint material, step 112.

The use of CTE-compliant materials ensures a reliable seal for overmolded assemblies, when there is positive compression of the CTE-compliant material within the specified operational temperature range. This sealing mechanism may operate without the need for material adhesion and instead, may rely on uniform compression, akin to a compressed O-ring, to create an effective environmental seal.

The CTE complaint material used for various embodiments may include heat shrink tubing. A person skilled in the art may readily recognize that a heat shrink tubing is used here as an example only, and other materials that are functionally equivalent may also be used and such use is within the spirit and scope of this invention.

In an embodiment, the CTE compliant material used may be of lower durometer than that of the overmold material and the sub-assembly material. Because the compliant material is softer, the outside diameter (OD) of the CTE compliant material may match or be compatible with that of the overmold (OVM) material and the internal diameter (ID) of the CTE compliant material may match or be compatible with that of the sub-assembly material. The outer diameter (OD) of the CTE compliant material in in contact with the OVM material, and the inner diameter (ID) of the CTE compliant material is in contact with the outer diameter of the cable material.

Thus, the CTE change of OD and ID will be as follows:

$$Δ OD = ( OD of CTE complaint material at rest ) \times α \times Δ T + d$$

where:
ΔOD is the compression on the CTE compliant material;
α is the CTE of overmold material;
ΔT is the change in temperature during overmolding to resting temperature; and
d is a dimensional change of the phase change of the overmold material.

ΔOD may be designed to follow:

$$Δ OD > OD \times CTE \times ( Δ Tp )$$

where ΔTp is the production operational temperature range of the finished product (e.g., (e.g., −40° C. to 90° C.). Also, the 40D may be designed to be less than the elastic limit of the CTE compliant material.

Length of the CTE compliant material to be deposited on the cable may be determined as a range where (5×ID)>L< (2.5× ID), and where L is the length of the CTE compliant material.

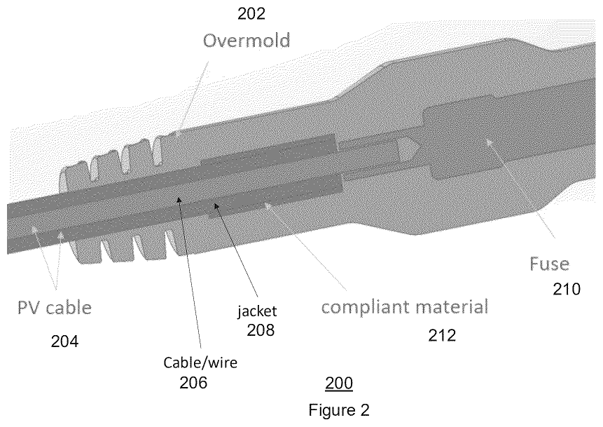

FIG. 2 illustrates an example system 200 for providing a superior seal for an overmolded assembly according to one or more embodiments described herein. For example, in an embodiment, the system for providing a superior seal for an overmolded assembly for a cable includes at least one cable 204 and an overmold, 202 for at least one cable 204, wherein Coefficient of Thermal Expansion (CTE) compliant material 212 is provided around the at least one cable 204, and the overmold 202 is provided around the assembly of the at least one cable 204 and the CTE compliant material 212 such that the CTE compliant material 212 is sandwiched between the at least one cable 204 and the overmold 202 for the at least one cable 204 to form a seal preventing a gap formed between the at least one cable 204 and the overmolding 202 for at least one cable 204 due to difference in coefficients of thermal expansion between the material used for the at least one cable 204 and the material used for the overmold 202 for at least one cable 204.

In one or more embodiments, the coefficient of thermal expansion of the compliant material 212 is compatible with that of the material used for the at least one cable 204 and the material used for the overmold 202 for at least one cable 204.

Additionally, or alternatively, the CTE complaint material 212 used for such seal may be chemically compatible and/or matching with that of the material used for the cable 204 as well as the material used for the overmold 202.

In one or more embodiments, length of the CTE compliant material to be deposited on the cable may be determined as a range depending on the outside diameter of the CTE complaint material and inside diameter of the CTE complaint material.

The CTE complaint material used for various embodiments may include heat shrink tubing. A person skilled in the art may readily recognize that a heat shrink tubing is used here as an example only, and other materials that are functionally equivalent may also be used and such use is within the spirit and scope of this invention.

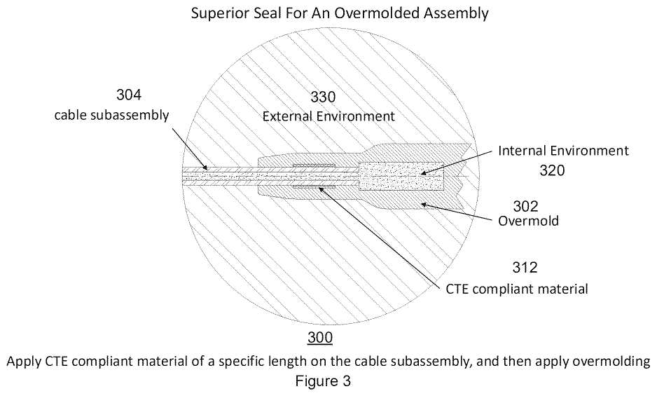

FIG. 3 illustrates an example system 300 for providing a superior seal for an overmolded assembly according to one or more embodiments described herein. For example, in an embodiment, the system for providing a superior seal for an overmolded assembly for a cable 304 includes at least one cable 304 and overmold 302 for at least one cable 304 where the overmold 302 is molded to the cable 304 forming an assembly, wherein CTE compliant material 312 is provided between the at least one cable 304 and the overmold 302 for at least one cable to form a seal 312 preventing a gap formed due to difference in coefficients of thermal expansion between the material used for the at least one cable 304 and the material used for the overmold 302 for at least one cable.

In one or more embodiments, the coefficient of thermal expansion of the compliant material 312 is compatible with that of the material used for the at least one cable 304 and the material used for the overmold 302 for at least one cable 304.

Additionally, or alternatively, the material used for such seal 312 may be chemically compatible and/or matching with that of the material used for the cable 304 as well as the material used for the overmold 302.

The CTE complaint material used for various embodiments may include heat shrink tubing. A person skilled in the art may readily recognize that a heat shrink tubing is used here as an example only, and other materials that are functionally equivalent may also be used and such use is within the spirit and scope of this invention.

The external environment 330 as illustrated refers to the outside of the product and internal environment 320 refers to the protected envelop using the overmold 302 assembled enclosure, and the CTE complaint material 312 as a superior seal.

As illustrated in FIGS. 2 and 3, the compliant material forms a seal between the overmold and the cable jacket. The compliant material can shrink during the overmolding process, functioning as a seal that uniformly compresses the CTE compliant material. This compression can be explained as follows: during the overmolding process, the plastic transitions from a liquid to a solid state, with temperatures changing from the injection temperature to the resting temperature. The product design accounts for the following: the size reduction during the overmold material's liquid-to-solid phase shift, combined with the coefficient of thermal expansion (CTE) size change from solid to resting temperature, must exceed the CTE of the item being overmolded across the intended temperature range (e.g., −40° C. to 90° C.).

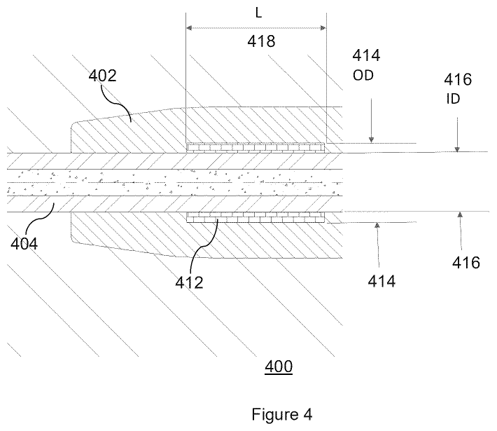

FIG. 4 illustrates an example system 400 for providing a superior seal for an overmolded assembly according to one or more embodiments described herein. For example, in an embodiment, the CTE compliant material used may be of lower durometer than that of the overmold material and the sub-assembly material. Because the compliant material is softer, the outside diameter (OD) 414 of the CTE compliant material may match or be compatible with that of the overmold (OVM) material and the internal diameter (ID) 416 of the CTE compliant material may match or be compatible with that of the sub-assembly material. The outer diameter (OD) 414 of the CTE compliant material in in contact with the OVM material, and the inner diameter (ID) 416 of the CTE compliant material is in contact with the outer diameter of the cable material.

Thus, the CTE change of OD 314 and ID 416 will be as follows:

$$Δ OD = ( OD of CTE complaint material at rest ) \times α \times Δ T + d$$

where:
ΔOD is the compression on the CTE compliant material;
α is the CTE of overmold material;
ΔT is the change in temperature during overmolding to resting temperature; and
d is a dimensional change of the phase change of the overmold material.

ΔOD may be designed to follow:

$$Δ OD > OD \times CTE \times ( Δ Tp )$$

where ΔTp is the production operational temperature range of the finished product (e.g., (e.g., −40° C. to 90° C.). Also, the ΔOD may be designed to be less than the elastic limit of the CTE compliant material 412.

Length 418 of the CTE compliant material 412 to be deposited on the cable may be determined as a range, for example, (5× ID)>L< (2.5× ID), where L is the length 418 of the CTE compliant material 412.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

1. A sealed cable and overmold assembly comprising:
a cable comprising a first material having a first coefficient of thermal expansion (CTE);
an overmold comprising a second material having a second CTE, the overmold surrounding a portion of a length of the cable; and
a third material having a third CTE disposed between the cable and the overmold surrounding the portion of the length of the cable, the third material forming a seal therebetween, the third material configured to maintain the seal between the cable and the overmold over a range of temperatures.

2. The assembly of claim 1, wherein the range of temperatures is between approximately-40° C. and approximately +90° C.

3. The assembly of claim 1, wherein:
the cable comprises a cable jacket, the cable jacket having the first material with the first CTE; and
the seal formed by the third material prevents environmental ingress between the cable jacket and the overmold over the range of operating temperatures.

4. The assembly of claim 1, wherein the third material having the third CTE is selected such that, upon thermal expansion or contraction of the assembly, the third material remains in sealing contact with both the cable and the overmold.

5. The assembly of claim 1, wherein the third CTE is different than the first CTE and the second CTE, the third material comprising heat shrink tubing.

6. The assembly of claim 1, wherein an extent of the third material disposed between the cable and the overmold is smaller than an extent of the cable that the overmold surrounds.

7. The assembly of claim 1, wherein:
the overmold has a length defined along a length of the cable;
the third material has a length defined along the length of the cable; and
the length of third material is less than the length of the overmold.

8. The assembly of claim 1, wherein:
the third material has a length defined along the length of the cable; and
the length of the third material is dependent upon an inner diameter of the third material.

9. The assembly of claim 6, wherein the length of the third material satisfies the relationship:
$$( 5 \times ID ) > L > ( 2 \text{.5} \times ID )$$
where:
L is the length of the third material; and
ID is the inner diameter of the third material.

10. The assembly of claim 1, wherein the third material is a material having a compression (ΔOD) that satisfies the relationship:
$$Δ OD > OD \times CTE \times ( Δ Tp )$$
where:
ΔOD is the compression of the third material;
OD is an outer diameter of the third material;
CTE is the coefficient of thermal expansion of the third material; and
ΔTp is a production operational temperature range of the system.

11. The assembly of claim 1, wherein the overmold does not provide a seal about the portion of the length of the cable.

12. A method for sealing a cable to an overmold assembly using a sealing material, the method comprising:
providing a cable comprising a cable material having a first coefficient of thermal expansion (CTE);
applying a sealing material to the cable, the sealing material having a third CTE; and
applying an overmold on top of the sealing material, the overmold comprising an overmold material having a second CTE, the overmold configured to compress the sealing material against the cable and form a seal between the cable and the overmold; wherein
the first CTE of the cable material is different than the second CTE of the overmold material.

13. The method of claim 12, wherein the third CTE of the sealing material is compatible with the first CTE of the cable material and the second CTE of the overmold material.

14. The method of claim 13, wherein the first CTE of the cable material, the second CTE of the overmold material, and the third CTE of the sealing material are selected such that across an operating range of temperatures, the sealing material maintains the seal between the cable and the overmold.

15. The method of claim 12, wherein the sealing material is chemically compatible with both the cable material and the overmold material.

16. The method of claim 12, wherein a length of the sealing material to be deposited on the cable is dependent upon an outer diameter and an inside diameter of the scaling material.

17. An apparatus comprising:
a cable;
a cable jacket disposed on the cable;
a sealing material disposed about the cable jacket; and
an overmold disposed around the sealing material and the cable jacket; wherein
the sealing material has a coefficient of thermal expansion (CTE) selected to create a seal between the cable jacket and the overmold and prevent environmental ingress between the cable jacket and the overmold over a range of operating temperatures.

18. The apparatus of claim 17, wherein the CTE of the sealing material is selected such that, upon thermal expansion or contraction of the apparatus, the sealing material remains in sealing contact with both the cable jacket and the overmold.

19. The apparatus of claim 17, wherein the sealing material has a durometer lower than that of the cable jacket and of the overmold.

20. The apparatus of claim 17, wherein the overmold comprises a polymer material configured to shrink when transitioning from a liquid to a solid and compress the sealing material against the cable jacket.
